(19) United States
(12) Patent Application Publication
(10) Pub. No.: US 2015/0127657 A1
(43) Pub. Date: May 7, 2015

(54) Method and Computer for Indexing and Searching Structures

(71) Applicant: Jiun Hung, Hsinchu City (TW)

(72) Inventor: Jiun Hung, Hsinchu City (TW)

(21) Appl. No.: 14/594,182

(22) Filed: Jan. 12, 2015

Related U.S. Application Data
(63) Continuation of application No. 14/027,151, filed on Sep. 13, 2013.
(60) Provisional application No. 61/702,268, filed on Sep. 18, 2012.
(60) Provisional application No. 61/708,634, filed on Oct. 1, 2012.

(51) Int. Cl. G06F 17/30

(52) U.S. Cl. CPC G06F 17/30321; G06F 17/30477
USPC 707/741

(57) ABSTRACT

A method for indexing a plurality of structures, which are derived from a plurality of externalizations of users' mental models, is provided. The method comprises receiving at least one of the plurality of structures; analyzing the at least one structure according to a predetermined principle of normalization to obtain a plurality of index analysis results in a form of a plurality of tuples comprising a plurality of elements and/or a plurality of relations thereof related to the plurality of structures; and generating an index store according to the index analysis result; wherein each externalized relation indicates each externalized sequence from one of externalized elements to another one of the externalized elements; wherein each relation indicates each sequence from one of a plurality of elements to another one of the plurality of elements.

### CROSS REFERENCE TO RELATED APPLICATIONS

This is a continuation application of U.S. application Ser. No. 14/027,151, filed Sep. 13, 2013 and claiming the benefit of both U.S. Provisional Application No. 61/702,268, filed on Sep. 18, 2012 and entitled “METHODS AND SYSTEMS FOR STRUCTURAL INDEX AND SEARCH WITH OPEN SCHEMA” and U.S. Provisional Application No. 61/708,634, filed on Oct. 1, 2012 and entitled “SEARCH SYSTEMS AND METHODS GROUNDED ON STRUCTURAL COGNITIVE CHARACTERISTICS”, which is included in its entirety herein by reference.

### BACKGROUND OF THE INVENTION

1. Field of the Invention

The application relates to a method and a computer system for indexing and searching a plurality of structures, and more particularly, to a method and a computer system for indexing and searching a plurality of structures derived from a plurality of externalizations of users' mental models.

2. Description of the Prior Art

To address the issue of retrieving documents from certain corpuses, conventional search engines take the following approach: extracting meaningful words from documents and taking them as units for indexing, building inverted index files accordingly, calculating degrees of relevance between user specified queries and all indexed documents whenever a user query comes in, and returning documents with higher degree of relevance to the user.

Conventional search engines ask users to provide one or more keywords to specify their documents of interests. However, without structural implications, search service systems often return documents containing user-specified query terms but hardly meeting users' demands as expected. The reason is that users' interests or intentions could not be precisely identified by only a number of separate tokens. In essence, the presentation of a user's intent is to be defined in terms of her/his own interpretation or recognition associated with the query targets. Users interpret and locate their search targets, as an object in cognition, within an established mental schema or cognition, and interpret their understandings of the search targets with pre-conceived ideas in particular schema (s). Such schema revealed in cognition are hierarchical or inter-related, in other words, are structural; and multiple tags that do not bear structural implications cannot represent hierarchies and inter-relationships existing in different concepts in cognition. However, popular modern search engines request information seekers to use multiple keywords without structural implications to specify their query targets, and result in inefficient searching for the information seekers.

Moreover, individuals' ontologies or categorizations for externally model a knowledge domain might be different due to diverse background knowledge and different interpretations. Each one may specify the query targets based on her/his individual ontologies or categorizations, which contributes lots of improvements for the search service systems to provide precise responses corresponding to different users' requirements. Therefore, it is an important issue to provide an innovative approach for indexing and searching the plurality of structures that are derived from the externalization of users' mental models.

### SUMMARY OF THE INVENTION

It is therefore an objective of the invention to provide a method and a computer system for indexing and searching a plurality of structures derived from a plurality of externalizations of users' mental models.

An embodiment of the invention discloses a method for indexing a plurality of structures, which are derived from a plurality of externalizations of users' mental models, the method comprising receiving at least one of the plurality of structures; analyzing the at least one structure according to a predetermined principle of normalization to obtain a plurality of index analysis results in a form of a plurality of tuples comprising a plurality of elements and/or a plurality of relations thereof related to the plurality of structures; and generating an index store according to the index analysis result; wherein the plurality of externalizations of users' mental models are obtained via a mind map, a concept map, a knowledge map, a diagram, a flow, a chart or a category; wherein each of the plurality of externalizations of users' mental models is an established mental schema or cognition for interpreting users' understandings of certain search targets in a form of externalized elements and externalized relations thereof, and each of the externalized relations indicates each externalized sequence from one of the externalized elements to another one of the externalized elements; wherein each of the plurality of structures derived from a corresponding one of the plurality of externalizations of users' mental models comprises a plurality of elements and a plurality of relations thereof, each of the plurality of elements is obtained via a text, an image, a sound, a video or any symbols representing a user's concept, conception, idea or other mental contents, and each of the plurality of relations is obtained as a hierarchy, a sequential order, a logical dependency or other specified states of affairs among the plurality of elements and indicates each sequence from one of the plurality of elements to another one of the plurality of elements.

Another embodiment of the invention also discloses a computer system for indexing a plurality of structures, which are derived from a plurality of externalizations of users' mental models, the computer system comprising a central processing unit; a user interface coupled to the central processing unit; and a storage device coupled to the central processing unit for storing a programming code, and the programming code is utilized to instruct the central processing unit for processing a method comprising receiving at least one of the plurality of structures via the user interface; analyzing the at least one structure according to a predetermined principle of normalization to obtain a plurality of index analysis results in a form of a plurality of tuples comprising a plurality of elements and/or a plurality of relations thereof related to the plurality of structures; and generating an index store according to the index analysis result; wherein the plurality of externalizations of users' mental models are obtained via a mind map, a concept map, a knowledge map, a diagram, a flow, a chart or a category; wherein each of the plurality of externalizations of users' mental models is an established mental schema or cognition for interpreting users' understandings of certain search targets in a form of externalized elements and externalized relations thereof, and each of the externalized relations indicates each externalized sequence from one of the externalized elements to another one of the externalized elements; wherein each of the plurality of structures derived from a corresponding one of the plurality of externalizations of users' mental models comprises a plurality of elements and a plurality of relations thereof, each of the plurality of elements is obtained via a text, an image, a sound, a video or any symbols representing a user's concept, conception, idea or other mental contents, and each of the plurality of relations is obtained as a hierarchy, a sequential order, a logical dependency or other specified states of affairs among the plurality of elements and indicates each sequence from one of the plurality of elements to another one of the plurality of elements.

Another embodiment of the invention also discloses a method for searching a plurality of structures, which are derived from a plurality of externalizations of users' mental models, the method comprising receiving at least one search query identifying one of the plurality of structures; analyzing the at least one structure according to a predetermined principle of normalization, to obtain a plurality of search analysis results in a form of a plurality of tuples comprising a plurality of elements and/or a plurality of relations thereof related to the plurality of structures; processing an identification search process to identify, in an index store, a plurality of structures comprising at least one of the plurality of tuples; performing a calculation operation for a plurality of identified structures according to predetermined principles of relevancy, so as to obtain a plurality of relevancy analysis results; ranking the plurality of identified structures according to the plurality of relevancy analysis results, to obtain a search report; and outputting the search report to a user's terminal; wherein the predetermined principles of relevancy comprise at least one or more principles of similarity calculation for the plurality of structures, and the plurality of externalizations of users' mental models are obtained via a mind map, a concept map, a knowledge map, a diagram, a flow, a chart, or a category; wherein each of the plurality of externalizations of users' mental models is an established mental schema or cognition for interpreting users' understandings of certain search targets in a form of externalized elements and externalized relations thereof, and each of the externalized relations indicates each externalized sequence from one of the externalized elements to another one of the externalized elements; wherein each of the plurality of structures derived from a corresponding one of the plurality of externalizations of users' mental models comprises a plurality of elements and a plurality of relations thereof, each of the plurality of elements is obtained via a text, an image, a sound, a video or any symbols representing a user's concept, conception, idea or other mental contents, and each of the plurality of relations is obtained as a hierarchy, a sequential order, a logical dependency or other specified states of affairs among the plurality of elements and indicates each sequence from one of the plurality of elements to another one of the plurality of elements.

Another embodiment of the invention also discloses a computer system for searching a plurality of structures, which are derived from a plurality of externalizations of users' mental models, the computer system comprising a central processing unit; a user interface coupled to the central processing unit; and a storage device coupled to the central processing unit for storing a programming code, and the programming code is utilized to instruct the central processing unit for processing a method comprising receiving at least one search query identifying one of the plurality of structures via the user interface; analyzing the at least one structure according to a predetermined principle of normalization, to obtain a plurality of search analysis results in a form of a plurality of tuples comprising a plurality of elements and/or a plurality of relations thereof related to the plurality of structures; processing an identification search process to identify, in an index store, a plurality of structures comprising at least one of the plurality of tuples; performing a calculation operation for a plurality of identified structures according to predetermined principles of relevancy, so as to obtain a plurality of relevancy analysis results; ranking the plurality of identified structures according to the plurality of relevancy analysis results, to obtain a search report; and outputting the search report to a user's terminal via the user interface; wherein the predetermined principles of relevancy comprise at least one or more principles of similarity calculation for the plurality of structures, and the plurality of externalizations of users' mental models are obtained via a mind map, a concept map, a knowledge map, a diagram, a flow, a chart, or a category; wherein each of the plurality of externalizations of users' mental models is an established mental schema or cognition for interpreting users' understandings of certain search targets in a form of externalized elements and externalized relations thereof, and each of the externalized relations indicates each externalized sequence from one of the externalized elements to another one of the externalized elements; wherein each of the plurality of structures derived from a corresponding one of the plurality of externalizations of users' mental models comprises a plurality of elements and a plurality of relations thereof, each of the plurality of elements is obtained via a text, an image, a sound, a video or any symbols representing a user's concept, conception, idea or other mental contents, and each of the plurality of relations is obtained as a hierarchy, a sequential order, a logical dependency or other specified states of affairs among the plurality of elements and indicates each sequence from one of the plurality of elements to another one of the plurality of elements.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a computer system according to an embodiment of the invention.

FIG. 2 is a flow chart of an index process according to an embodiment of the invention.

FIG. 3 is a flow chart of a search process according to an embodiment of the invention.

FIG. 4 illustrates a schematic diagram of a general categorization according to an embodiment of the invention.

FIG. 5 illustrates a schematic diagram of a mind map according to an embodiment of the invention.

FIG. 6 illustrates a schematic diagram of an index schematic table according to an embodiment of the invention.

FIG. 7 illustrates another schematic diagram of an index schematic table according to an embodiment of the invention.

FIG. 8 illustrates a schematic diagram of another index schematic table with ranking according to an embodiment of the invention.

### DETAILED DESCRIPTION

The specification and the claims of the present invention may use a particular word to indicate an element, which may have diversified names named by distinct manufacturers. The present invention distinguishes the element depending on its function rather than its name. The phrase “comprising” used in the specification and the claim is to mean “is inclusive or open-ended but not exclude additional, un-recited elements or method steps.” In addition, the phrase “electrically connected to” or “coupled” is to mean any electrical connection in a direct manner or an indirect manner. Therefore, the description of “a first device electrically connected or coupled to a second device” is to mean that the first device is connected to the second device directly or by means of connecting through other devices or methods in an indirect manner.

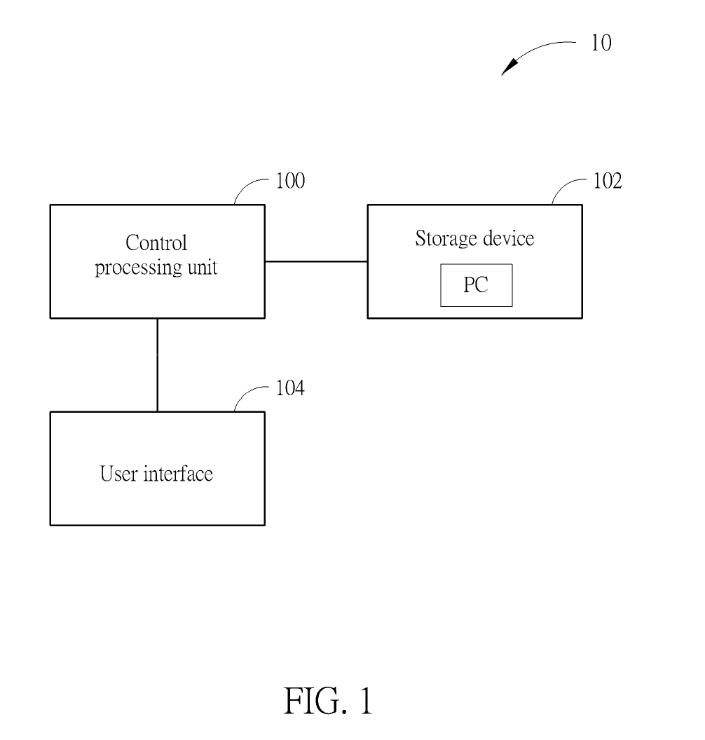

Please refer to FIG. 1, which illustrates a schematic diagram of a computer system 10 according to an embodiment of the invention. The computer system 10 comprises a central processing unit 100, a storage device 102 and a user interface 104. Certainly, the computer system 10 is not limited to comprising the above-mentioned elements/modules/circuits only, i.e. the computer system 10 may further comprises the motherboard, the memory, the hard disk (HD), the south bridge module, the north bridge module, the display panel, etc. In the embodiment, the central processing unit 100 may refer to any form of electronical device including, but not limited to, commodity CPU and GPU, which can execute instructions for realizing the indexing, relevance calculating, and other functionalities required in the embodiment. Moreover, multiple central processing units could be tightly and/or loosely coupled with each other. The central processing unit 100 is coupled to the storage device 102. Likewise, the storage device 102 may refer to any form of device including, but not limited to, magnetic disk, RAID, solid state storage, optical storage, which can accommodate program codes (instructions), users' input data, intermediate operation results, data base, and any other contents required in the embodiment. Similarly, multiple storage devices could be tightly and/or loosely coupled with each other. Also, the storage module 102 stores a programming code PC that is eligible to instruct the central processing unit 100 for processing an index method as well as a search method. The user interface 104 can be realized as a keyboard, a mouse, a joystick, a touch/display device, a mobile device or any electronic device via a wired/wireless transmission with the central processing unit 100 for providing electronic input signals, such that users can utilize the user interface 104 to create, edit, collect and share the contents of their mental models. Also, the central processing unit 100, the storage module 102 and the user interface 104 could be connected with each other in tightly-coupled (single site) or loosely-coupled (distributed) style, which is not limiting the scope of the invention.

Specifically, the computer system 10 is utilized to process a plurality of structures which are derived from a plurality of externalizations of users' mental models. The plurality of externalizations of users' mental model are obtained via a mind map, a concept map, a knowledge map, a diagram or a category, which means that the plurality of externalizations of users' mental model can be regarded as an established mental schema or cognition (i.e. pre-conceived ideas in particular schemas) for interpreting the users' understandings of certain search targets as an object in cognition. Also, each of the plurality of structures derived from the plurality of externalizations of the users' mental models comprises a plurality of elements and a plurality of relations thereof, wherein each of the plurality of elements is obtained via a text, an image, a sound, a video or any symbols representing a user's conception, idea or mental content, and each of the plurality of relations is obtained as a hierarchy, a sequence order, a logical dependency or any specified state of affairs among the plurality of elements, which is not limiting the scope of the invention.

The storage device 102 of the embodiment may store/prepare with a predetermined principle of normalization as a programming code to implement a process of normalizing structures in the form of tuple. The principle of normalization comprise a segmentation information according to a length of capacity limits of human cognition, such as the length of memory span, and the embodiment of the invention may predetermine, but not limited to, the length of capacity limits as a number of 4, 5, 7 or 9. Besides, the storage device 102 of the embodiment may also store/prepare with a plurality of predetermined principles of relevancy as another programming code to implement at least one or more principles of similarity calculation for the plurality of structures. Both the programming codes of the predetermined principle of normalization as well as the plurality of predetermined principles of relevancy may be operated to be cooperated with the programming code PC for processing the index method as well as the search method, which is also in the scope of the invention.

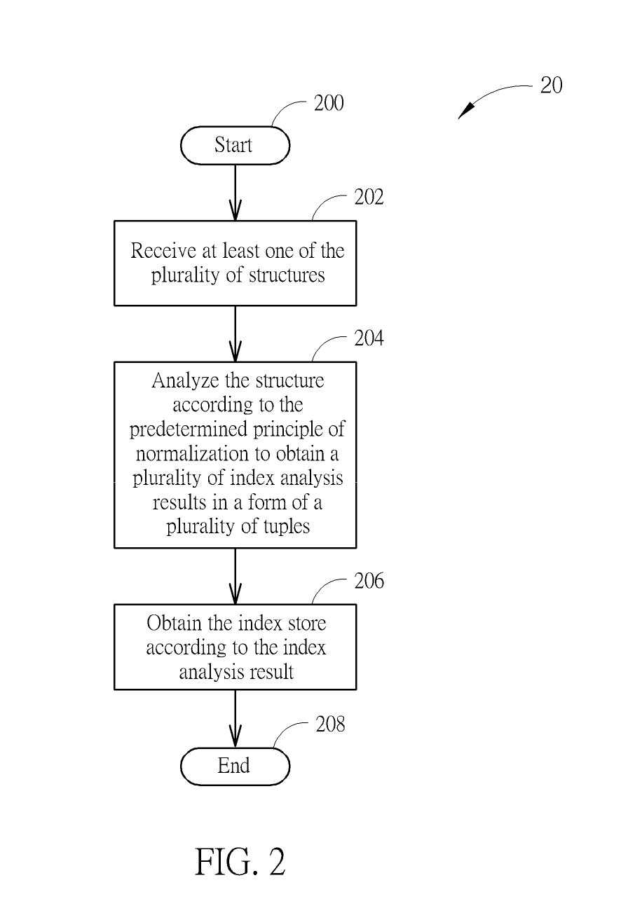

In the embodiment, the index method, compiled as the programming code PC, can be directly summarized as an index process 20, as shown in FIG. 2. The index process 20 comprises, but not limited to, the following steps:

Step 200: Start.

Step 202: Receive at least one of the plurality of structures.

Step 204: Analyze the structure according to the predetermined principle of normalization to obtain a plurality of index analysis results in a form of a plurality of tuples.

Step 206: Obtain the index store according to the index analysis result.

Step 208: End.

In step 202, the computer system 10 utilizes the user interface 104 to receive the at least one of the plurality of structures. Also, a local area network (LAN) or a wide area network (WAN) can be cooperated with the computer system 10, such that other computer systems or users can share/interchange the plurality of structures with/through a plurality of the computer system 10 of the embodiment, which is also in the scope of the invention.

In step 204, the computer system 10 utilizes the processing unit 100 to analyze the structure according to the predetermined principle of normalization, so as to obtain the plurality of index analysis results in the form of the plurality of tuples, wherein the tuples of the embodiment comprises the plurality of elements and/or the plurality of relations thereof related to the plurality of structures. Suppose there is a structure structure_{—}01:{g, b, f, A, H, c, j, e, i, d}, in one interpretation, the element may be the appeared alphabet, and the relation is the order in their appearance, then the normalized representation of structure_{—}01 is to be the tuple of (g, b, f, A, H, c, j, e, i, d). In another interpretation, the element of the structure structure_{—}01 may be the lowercase letter, and the relation is interpreted as the alphabetic serial order, then the normalized representation of structure_{—}01 may be the tuple of (b, c, d, e, f, g, i, j); the tuple for the second interpretation can also be formulated as the tuple of (j, i, g, f, e, d, c, b), the reversed one, as long as the designed schema can meet the requirement for the specified interpretation. In the embodiment, the principle of normalization, as an interpretation of specification, can vary with the specifications for different discourses of applications. Such variety may be illustrated with several embodiments later in following paragraphs.

Additionally, it is rational to exclude that the analysis of long structure may meet the requirement of meaningful results as well as computation efficiency. Based on that consideration, the system parses the tuple of the original structure into finite index process units in the form of tuples, i.e. the index analysis results, by segmenting with every certain number of consecutive nodes according to the segmentation information while performing indexing operations. In one embodiment, if the segmentation information is a number of 7, then structure_{—}01 is indexed with the index process units of (a, b, c, d, e, f, g), (b, c, d, e, f, g, h), (c, d, e, f, g, h, i), (d, e, f, g, h, i, j). In other words, the structure is indexed according to its index analysis results.

In step 206, the computer system 10 utilizes the processing unit 100 and the storage device 102 to store the index analysis result for further operations, so as to obtain the index store, which can also be stored in the computer system 10. What should be stressed, the index schema for the invention can be open for the system designs in need. The establishment of the index store of the embodiment can be implemented with various techniques known in the art. In one embodiment, the plurality of structures can be indexed with each of the tokens representing the elements of tuples. In another embodiment, the plurality of structures can be indexed with the string sequence representing the tuple. The operations of obtaining index may be explained with two embodiments as followed.

First, for a common discourse of the two embodiments, let the documents, be the retrieved structures normalized in the form of tuples; suppose the three documents in handled are
doc_{—}01=(A, X, B, Y, C, Z);
doc_{—}02=(C, Z, B, Y, X);
doc_{—}03=(A, B, Z, T).

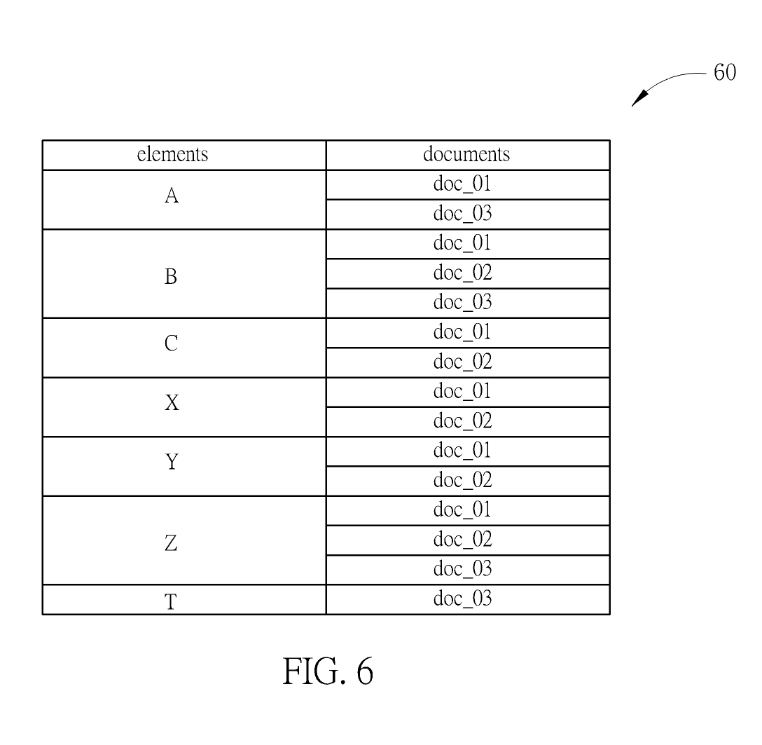

Please refer to FIG. 6, which illustrates a schematic diagram of an index schematic table 60 for the embodiment of indexing with elements. As shown in FIG. 6, the index schematic table 60 comprises seven elements A, B, C, X, Y, Z, T and three documents doc_{—}01, doc_{—}02 and doc_{—}03. The index schema 60 of the invention can be further predetermined with the programming codes stored in the computer system 10, and the search process 30 can be adaptively operated to identify the tuples comprising all the elements of at least one of the tuples of search analysis results and compute the similarity between the sequence of the identified tuple and the sequence of the tuple of the query target structure according to the principles of similarity predetermined as required. Notice again, the structure is indexed with its index analysis results. For example, in one embodiment, the segmentation information is a number of 3, then doc_{—}01 may not be identified by a target tuple of (A, B, C) because the analyzed index process units of doc_{—}01 are (A, X, B), (X, B, Y), (B, Y, C), and (Y, C, Z).

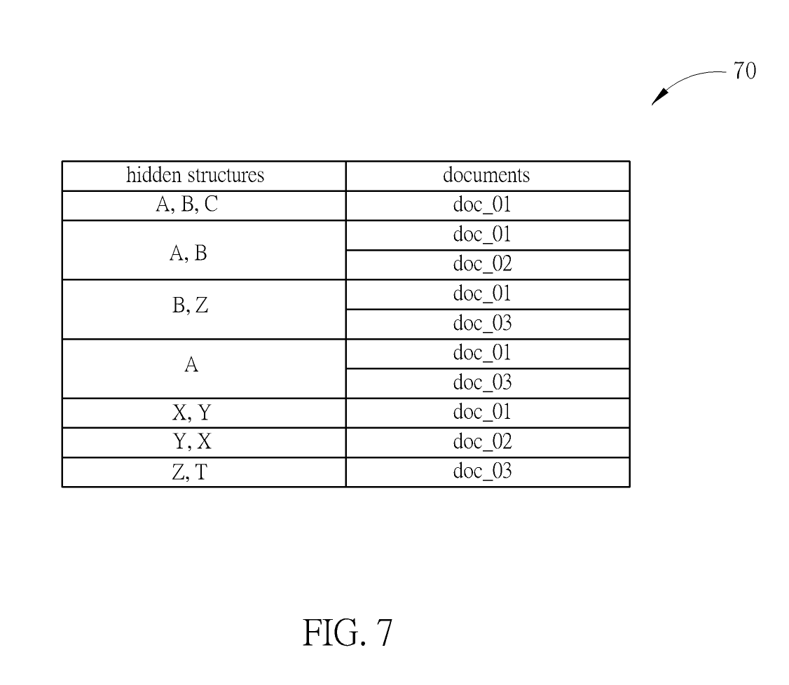

Also, please refer to FIG. 7, which illustrates another schematic diagram of an index schematic table 70 for an embodiment of indexing with the string sequences representing the tuples. As shown in FIG. 7, the index schematic table 70 comprises the hidden structures and the three documents doc_{—}01, doc_{—}02 and doc_{—}03. Initially, the systems will analyze all the subsequences, as the hidden structures of the structure. Suppose the document is schematically defined as (α, β, γ), then the hidden structures of the document analyzed, in one prototypical embodiment, is to be represented in the sequences of
(α, β, γ);
(α, β,);
(β, γ);
(α, γ);
(α);
(β);
(γ).

Any two of documents having a same hidden structure share a same key of the index. For example, doc_{—}01 and doc_{—}03 share the key of (A, B) because all of them have the hidden structure of (A, B). Likewise, doc_{—}01 and doc_{—}02 may further share the key of (B, Y) because they also have the hidden structure of (B, Y), but not for doc_{—}03. In practice, if a key of index does not exist, the system will create it; if existing, the system updates it with new documents. Accordingly, the index schema 70 of the invention may be also stored/prepared in the computer system 10, as well as the index store obtained. And please notice that again, the operation of analyzing hidden structures is only applied to the index process units of the structure, and thus the system establishes the index of the structure. The same example for doc_{—}01 with segmentation information of number 3 can also be the illustration here. The difference between the two embodiments is just the design way of index schema; one is done with (Intersection of) the elements, and the other is done with the sequences.

Noticeably, the above mentioned two embodiments of index schema can also be correlated with the raw data of original structures that are indexed with the tuples, in the way of, but not limited to, adding column (s) or accessing other module (s) storing the raw data, so that the system can refer to the original data for further utilization. Other required data are also eligible for the integration of the present embodiments, which is also in the scope of the invention.

Furthermore, during processing the index process 20, other parallel operations as receiving corresponding relevant data and establishing reference data store can be performed. Corresponding relevant data may be of all the data managed along with/for the mental model, such as, but not limited to, the data grouped under or defined with the structure, the note for edition, or user information. More examples can be illustrated in the following paragraphs.

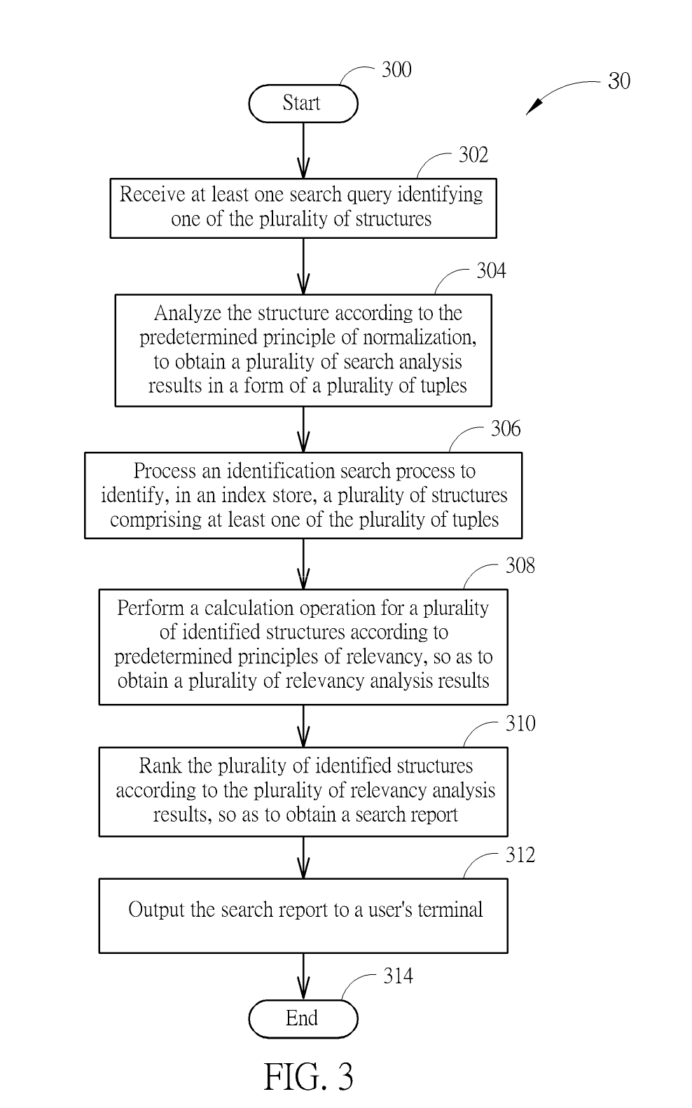

Further, the search method, also compiled as the programming code PC, can be directly summarized as a search process 30, as shown in FIG. 3. The search process 30 comprises, but not limited to, the following steps:

Step 300: Start.

Step 302: Receive at least one search query identifying one of the plurality of structures.

Step 304: Analyze the structure according to the predetermined principle of normalization, to obtain a plurality of search analysis results in a form of a plurality of tuples.

Step 306: Process an identification search process to identify, in an index store, a plurality of structures comprising at least one of the plurality of tuples.

Step 308: Perform a calculation operation for a plurality of identified structures according to predetermined principles of relevancy, so as to obtain a plurality of relevancy analysis results.

Step 310: Rank the plurality of identified structures according to the plurality of relevancy analysis results, so as to obtain a search report.

Step 312: Output the search report to a user's terminal.

Step 314: End.

In step 302, the computer system 10 utilizes the user interface 104 to receive at least one search query identifying one of the plurality of structures, and operations of step 302 can also be understood through operations of step 202 of the index process 20, so as to share/interchange the search query identifying one of the plurality of structures with other computer systems through the LAN and/or WAN, which is also in the scope of the invention.

In step 304, being aligned to step 204, the computer system 10 utilizes the processing unit 100 to analyze the structure according to the predetermined principle of normalization, so as to obtain the plurality of search analysis results in the form of the plurality of tuples. Also, the tuples of the embodiment comprises the plurality of elements and/or the plurality of relations thereof related to the plurality of structures. In addition, the system will reformulate the tuple of received structure into more tuples by permutation of elements, so as to make the query expanded.

In step 306, the computer system 10 utilizes the processing unit 100 to process the identification search process to identify the structures comprising at least one of the tuple of the search analysis via the index store, so as to obtain the plurality of identified structures. Besides, the identification search process also comprises other operation such as accessing the reference data store of the corresponding relevant data associated with the plurality of identified structures, and preparing the accessed reference data for further utilization.

In step 308, the computer system 10 utilizes the processing unit 100 to perform the calculation operation for the plurality of identified structures according to the predetermined principles of relevancy, so as to obtain the plurality of relevancy analysis results. In the embodiment, the predetermined principles of relevancy comprise at least one or more principles of similarity calculation for the plurality of structures. In detail, the tuples of the embodiment can be utilized as a normalized representation for the plurality of structures. In that, the calculation of structural similarity can be applied to such representations to measure and rank the plurality of structures according to the similarity of the tuples, i.e. the normalized representative sequences. The calculation of structural similarity for the tuples may be implemented, but not limited to, with the application of common techniques, such as Longest Common Subsequence (LCS), Vector Space Model (VSM), Edit Distance (ED), Structural Pattern Recognition, any combination of the above or other proposed techniques.

For example, suppose the analyzed tuples of received two query targets are QT_{—}01=(A, B, C) and QT_{—}02=(B, Z), and the tuples in handled remain doc_{—}01: (A, X, B, Y, C, Z), doc_{—}02: (C, Z, B, Y, X) and doc_{—}03: (A, B, Z, T). In one embodiment of LCS, if the user inputs the query target as for the query target QT_{—}01: (A, B, C), the documents doc_{—}01, doc_{—}02 and doc_{—}03 have corresponding values as doc_{—}01_LCS=(A, B, C), doc_{—}02_LCS=(B) and doc_{—}03_LCS=(A, B), respectively, and then ranking values of relevancy analysis can be obtained as doc_{—}01_rank=1, doc_{—}02_rank=3, and doc_{—}03_rank=2. In one embodiment of ED, if the user inputs the query target as for the query target QT_{—}02:(B, Z), the documents doc_{—}01, doc_{—}02 and doc_{—}03 have corresponding values as doc_{—}01_ED=4, doc_{—}02_ED=5 and doc_{—}03_ED=2, respectively, and then ranking values can be obtained as doc_{—}01_rank=2, doc_{—}02_rank=3, and doc_{—}03_rank=1.

In step 310, the computer system 10 utilizes the processing unit 100 to rank the plurality of identified structures according to the plurality of relevancy analysis results, so as to obtain the search report. In detail, the search report comprises a list of the plurality of identified structures in a rank of relevancy analysis results and/or the corresponding relevant data associated with the plurality of identified structures accordingly.

In step 312, the computer system 10 utilizes the processing unit 100 to output the search report to the user's terminal, such as the display panel coupled to the computer system 10, which is not limited in the scope of the invention.

In brief, with the prepared index store, the search process 30 is operated to analyze the inputted search query, so as to obtain the plurality of search analysis results in the form of the plurality of tuples, and accordingly, the identification search process as well as the calculation operation can be operated to obtain the plurality of relevancy analysis results, so as to rank the plurality of identified structures and correspondingly output the search report for the user (s). Accordingly, the embodiment of the invention utilizes the structural and/or structure-like information and/or the information of the structure that is derived from user's mental model, rather than split and individual tokens of words or phrase retrieved from the documents, as an index unit and query for retrieving relevant documents, so as to provide another innovative approach for indexing and searching the plurality of structures. More practical embodiments of the invention can be demonstrated hereinafter as different specification and the normalization of structures.

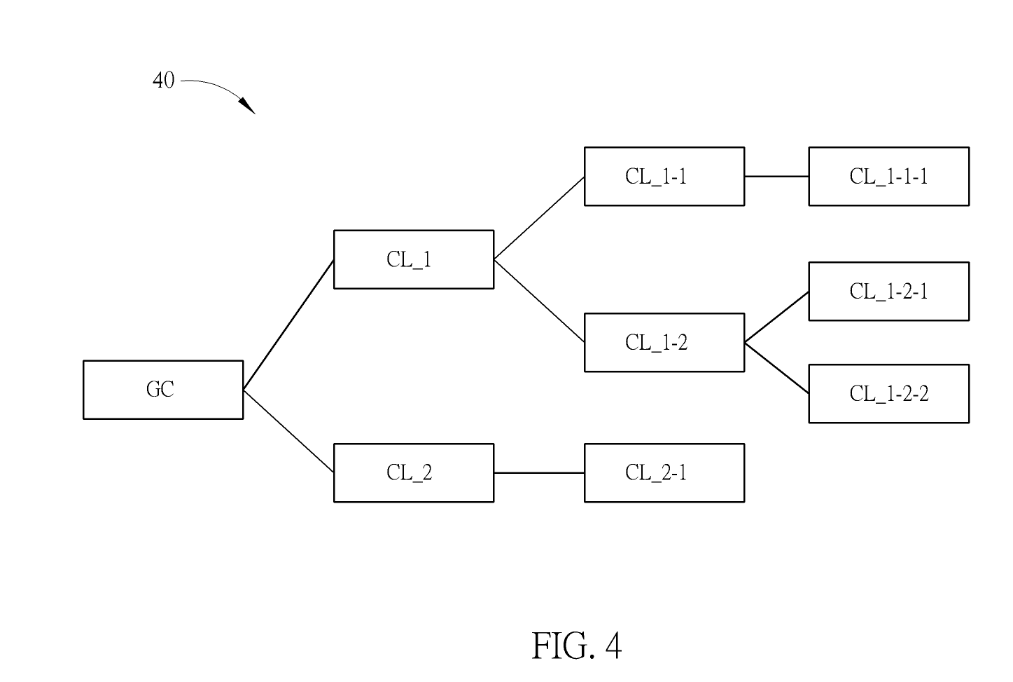

Hereinafter, several practical embodiments of the invention are introduced. First, one embodiment of the invention specifies the interpretation of specification and the normalization of structures as for the discourse of classifications and/or categorizations. The structures can be interpreted as the hierarchies of classifications and/or categorizations. In detail, the plurality of elements can be realized as word, images, voices, audios or any symbols representing users' expressions, and the plurality of relations can be realized as hierarchical denomination of classifications and/or categorizations. Please refer to FIG. 4, which illustrates a schematic diagram of a general categorization 40 according to an embodiment of the invention. As shown in FIG. 4, the tuple 40 can be a general categorization GC. The GC 40 may be first classified into two classifications CL_{—}1 and CL_{—}2. Next, the classification CL_{—}1 are further classified into two branch classifications CL_{—}1-1 and CL_{—}1-2, wherein the classification CL_{—}1-1 comprises a classification CL_{—}1-1-1, and the classification CL_{—}1-2 comprises two classifications CL_{—}1-2-1 and CL_{—}1-2-2. Also, the classification CL_{—}2 comprises a classification CL_{—}2-1. Accordingly, the structures obtained from the GC may comprises, in one interpretation, at least four categories as described, and the plurality of elements and the plurality of relations are the classifications and their corresponding hierarchical relations. In that, the structures defined in terms of the plurality of elements and the plurality of relations thereof of tuple GC 40 are obtained to be at least four categories, which can be analyzed in the form of tuples as
category_{—}01=(classification CL_{—}1, classification CL_{—}1-1, classification CL_{—}1-1-1);
category_{—}02=(classification CL_{—}1, classification CL_{—}1-2, classification CL_{—}1-2-1);
category_{—}03=(classification CL_{—}1, classification CL_{—}1-2, classification CL_{—}1-2-2);
category_{—}04=(classification CL_{—}2, classification CL_{—}2-1).

Certainly, the other categorizations of the invention can be realized with different classifications/categories, which is not limited the scope of the invention. Accordingly, the search query in the present embodiment may be a category of user's intend, which may also be presented, but not limited to, in the form of a sequence of classifications representing the hierarchy of the category. Once the user inputs the search query, the search report in the form of identified categories after ranking operation and the relevant data thereof will be provided, wherein the relevant data can be realized as user information, and collections grouped under categories such as hyperlinks, files, texts, sounds, videos, or images.

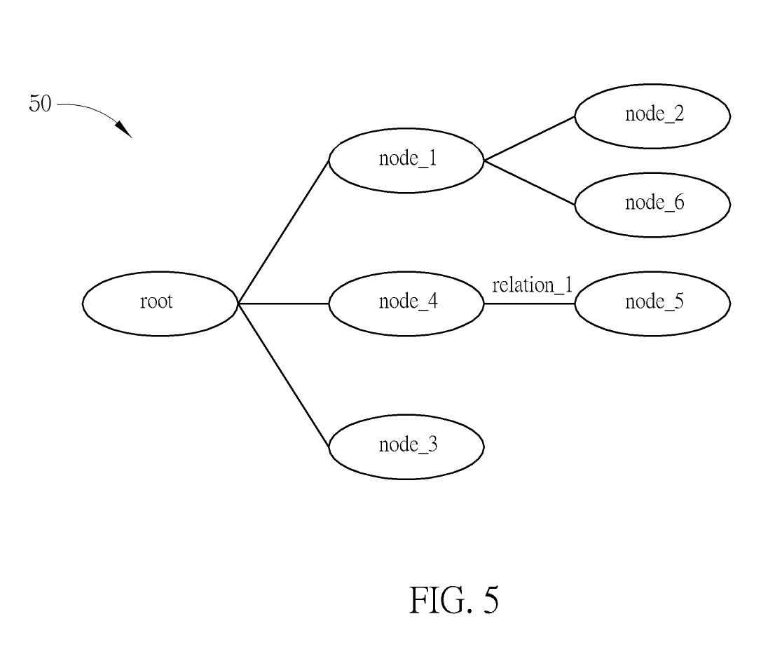

Moreover, another embodiment of the invention specifies the interpretation of specification and the normalization of structures as for the discourse of mind maps, concept maps or knowledge maps. The structures can be interpreted as the conceptual paths. In detail, the elements can be realized as the nodes, and the relations can be realized as correlations of the nodes. Please refer to FIG. 5, which illustrates a schematic diagram of a mind map 50 according to an embodiment of the invention. As shown in FIG. 5, the mind map 50 in the embodiment of the invention comprises six nodes node_{—}1˜node_{—}6 with presenting at least four conceptual paths. As shown, one is the path from root to node_{—}1 and then to node_{—}2; another is from root to node_{—}1, and then to node_{—}6; another is from root to node_{—}4, and then through a correlation named relation_{—}1 to node_{—}5; and the other is simply from root to node_{—}3. Let the nodes be the elements, and a correlation with particular annotation also be seen as an element, the four conceptual paths can be analyzed in the form of tuples, such as
path_{—}01=(root, node_{—}1, node_{—}2);
path_{—}02=(root, node_{—}1, node_{—}6);
path_{—}03=(root, node_{—}4, relation_{—}1, node_{—}5);
path_{—}04=(root, node_{—}3).

Certainly, the other mind maps of the invention can be realized with different nodes and relations, which is not limiting the scope of the invention. Accordingly, the search query in the present embodiment may be a conceptual path of user's intend, which may also be presented, but not limited to, in the form of a sequence of concepts. Once the user inputs the search query, the search report in the form of identified conceptual paths after ranking operation and the relevant data thereof will be provided, wherein the relevant data can be realized as the information of the map, the author, annotations of edition or other references.

Additionally, another embodiment of the invention specifies the interpretation of specification and the normalization of structures as for the discourse of diagrams or flows. The structure is interpreted as each process of the flow. In detail, the plurality of elements can be realized as inputs, actions, conditions, and/or outputs of the flows, and the plurality of relations can be realized as logical dependency of the inputs, the actions, the conditions, and the outputs of the flows. Also, the logical dependency can be marked with different annotations such as transitive, recursive, symmetric and/or asymmetric, so that the normalization can be defined as required designs. Processes of the flows may further comprise sub processes and so to be illustrated as different designs/levels of the flows. In one embodiment of the generic view, the tuple can be realized as
flow_{—}01=(state_{—}01, state_{—}02, . . . , state_n).

Accordingly, the search query in the present embodiment may be a process of user's intend, which may also be presented, but not limited to, in the form of a sequence of specified states. Once the user inputs the search query, the search report in the form of identified processes in the rank of data relevancy and the relevant data thereof will be provided, wherein the relevant data can be realized as actors, task owners, service providers, demanded resources (i.e. expenditures, labors, transportation, etc.) and/or physical indexes (i.e. time of process, temperature, etc.).

Further, another embodiment of the invention specifies the interpretation of specification and the normalization of structures as for the discourse of charts. The structure is interpreted as the tendency of indexes. In detail, the plurality of elements can be realized as tokens of one index value in the tendency, and the plurality of relations can be realized as locations of tokens in the specified dimension. Noticeably, measurement units corresponding to different charts can be easily transformed for different alignments, such that the locations of the tokens among different charts can be directly utilized to represent serial orders of the plurality of elements of the plurality of tuples. For example, the tuple of the tendency of an index, in one generic embodiment, can be realized as
index_{—}01_tendency=(value_token_{—}01, value_token_{—}02, value_token_{—}03 . . . ).

Under such circumstances, the search query in the present embodiment may be an index of user's intend, which may also be presented, but not limited to, in the form of a pattern of specified factors and dimensions. Once the user inputs the search query, the search report in the form of identified converges of index tendency after ranking operation and the relevant data thereof will be provided. The relevant data can be realized as names of indexes/products/markets related to different timings and/or relevant events, and certainly, the charts of the embodiment should not be limited to comprise the X-Y coordinate chart, X-Y-Z coordinate chart, and/or any graphic/pie chart/table/bar with easy transformation of measurement units.

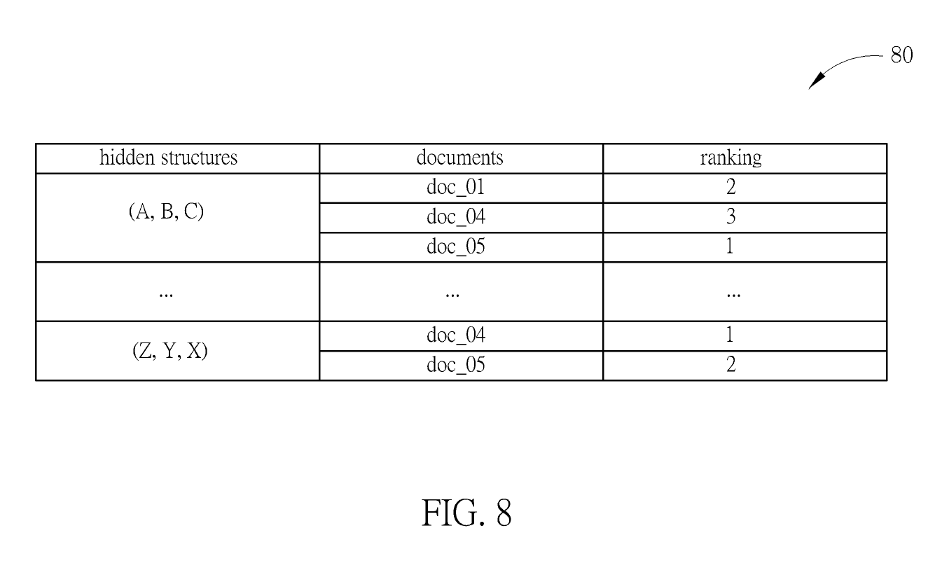

Notice that structures sharing a common key of the index may be seen as isomorphic. In the group of isomorphism, the systems can rank, in advance, the relevancy of every single document and store the value with the column “ranking”, according to the similarity between the sequence of the documents and the sequence of the index key, i.e. the index schematic table 80 with ranking as shown in FIG. 8. Suppose the two documents in handled are doc_{—}04=(A, Z, Y, B, X, C) and doc_{—}05=(A, B, Z, C, Y, X). Under one of prototypical definitions, let symbol (n) denote the sequential position of the element, the key (A, B, C) is denoted as (A(1), B(2), C(3)), doc_{—}04 as (A(1), Z(2), Y(3), B(4), X(5), C(6)), and doc_{—}05 as (A(1), B(2), Z(3), C(4), Y(5), X(6)). Comparing to the key (A, B, C), in one embodiment of VSM, doc_{—}05 may obtain better similarity than doc_{—}04 because the hidden structure of doc_{—}05 that shares the key (A, B, C) is (A(1), B(2), C(4)) where that of doc_{—}4 is (A(1), B(4), C(6)). Likewise, comparing to the key (Z, Y, X), doc_{—}04 may obtain a better similarity than doc_{—}05 because the hidden structure of doc_{—}04 that share the key (Z, Y, X) is (Z(2), Y(3), X(5)) where that of doc_{—}5 is (Z(3), Y(5), X(6)). In that, the systems can do sorting before query requesting since the relevancy calculation can be conducted while indexing. The processes for better computation efficiency described above are also in the scope of the invention.

Noticeably, all the mentioned embodiments can also be adaptively adjusted/modified/changed/transformed to fit any other common implementation for cooperation/integration together, such that the rules of normalization can be realized for both indexing and searching in one of the embodiments. Thus, the programming codes of the index process 20 and the search process 30 can be directly compiled into one or more programming code (s), such that the computer system 10 of the invention can conveniently process the programming code(s) for indexing and searching the plurality of structures, so as to provide the users the search report corresponding to the inputted search queries and the corresponding relevant data. Certainly, those skilled in the art can obtain the search report in the form as images, audios, voices, or any combinations of electronic files, which is not limiting the scope of the invention.

Particularly, the embodiment of the invention can also be utilized as an effective means of advertising with the essence of cognitive pattern recognition. Thus, the cognitive pattern recognition can inherit the similar predetermined principle of normalization and data relevancy as mentioned above by identifying similarity between the plurality of tuples and the plurality of structures. In practice, any two of individuals share a same (or similar) set of categories may very likely have many interests in common. For example, for two individuals having the categories such as “professional sports>USA>NBA” and “professional sports>USA>NFL” respectively for their collection of information, plausibly they may also be interested in daily message of professional sports, but not necessarily both interested in a new product of genuine leather basketball. In another case, for two that share “professional sports>USA>NBA”, if one has another like “travel>overseas>Asia”, he may be much more probably to purchase a ticket for NBA opening game at Shanghai than the other whose category for travels is defined as “travel>camping>the Great Lakes”.

The utilization of advertisement can also be achieved with the systems and methods of the invention explained above. In the embodiment, the structures in the index store are the target structures and the relevant data are the digital content, which are both predetermined for the requirements of advertisement. The received structure, as a search request to the system, may be of any request content, such as, but not limited to, an inputted user query, or the contents of categories, mind maps dumped in web page, etc. If the request structure matches the target structure, the digital content is provided in the response of the request.

Also, the embodiment of the invention can be utilized for social network groups and/or network forums, such that users comprising the similar interests and inclinations can be classified into the same sub-groups to share contact information with each other, which is also in the scope of the invention.

In last, those skilled in the art should adaptively make combinations, modifications and/or alterations on the abovementioned embodiment. The abovementioned steps of the index process 20 as well as the search process 30 comprising suggested steps can be realized by means that could be a hardware, a firmware known as a combination of a hardware device and computer instructions and data that reside as read-only software on the hardware device, or an electronic system. Examples of hardware can include analog, digital and mixed circuits known as microcircuit, microchip, or silicon chip. Examples of the electronic system can include a system on chip (SOC), system in package (SiP), a computer on module (COM), or any mobile communication devices, which is also in the scope of the invention.

In conclusion, the embodiment of the invention provides a method and a computer system for indexing and searching a plurality of structures that is derived from a plurality of externalizations of users' mental models. Based on an index store prepared with the predetermined principle of normalization, the inputted search queries can be identified, and further be measured with the predetermined principle of relevancy, so as to obtain a search report complying with users' requirements. Also, during the identification, the index store and the reference data store can also be updated to store relevant data/documents. In that, users comprising diverse background knowledge and different interpretations can adaptively obtain corresponding search report according to her/his individual ontologies or categorizations, and more efficient improvements of the computer system can be anticipated accordingly.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for indexing a plurality of structures, which are derived from a plurality of externalizations of users' mental models, the method comprising:
receiving at least one of the plurality of structures;
analyzing the at least one structure according to a predetermined principle of normalization to obtain a plurality of index analysis results in a form of a plurality of tuples comprising a plurality of elements and/or a plurality of relations thereof related to the plurality of structures; and
generating an index store according to the index analysis result;
wherein the plurality of externalizations of users' mental models are obtained via a mind map, a concept map, a knowledge map, a diagram, a flow, a chart or a category;
wherein each of the plurality of externalizations of users' mental models is an established mental schema or cognition for interpreting users' understandings of certain search targets in a form of externalized elements and externalized relations thereof, and each of the externalized relations indicates each externalized sequence from one of the externalized elements to another one of the externalized elements;
wherein each of the plurality of structures derived from a corresponding one of the plurality of externalizations of users' mental models comprises a plurality of elements and a plurality of relations thereof, each of the plurality of elements is obtained via a text, an image, a sound, a video or any symbols representing a user's concept, conception, idea or other mental contents, and each of the plurality of relations is obtained as a hierarchy, a sequential order, a logical dependency or other specified states of affairs among the plurality of elements and indicates each sequence from one of the plurality of elements to another one of the plurality of elements.

2. The method of claim 1, further comprising:
receiving corresponding relevant data associated with the plurality of structures and establishing a reference data store for the corresponding relevant data.

3. The method of claim 1, wherein the predetermined principle of normalization comprises a segmentation information representing a particular number indicating a length of memory span.

4. A computer system for indexing a plurality of structures, which are derived from a plurality of externalizations of users' mental models, the computer system comprising:
a central processing unit;
a user interface coupled to the central processing unit; and
a storage device coupled to the central processing unit for storing a programming code, and the programming code is utilized to instruct the central processing unit for processing a method comprising:
receiving at least one of the plurality of structures via the user interface;
analyzing the at least one structure according to a predetermined principle of normalization to obtain a plurality of index analysis results in a form of a plurality of tuples comprising a plurality of elements and/or a plurality of relations thereof related to the plurality of structures; and
generating an index store according to the index analysis result;
wherein the plurality of externalizations of users' mental models are obtained via a mind map, a concept map, a knowledge map, a diagram, a flow, a chart or a category;
wherein each of the plurality of externalizations of users' mental models is an established mental schema or cognition for interpreting users' understandings of certain search targets in a form of externalized elements and externalized relations thereof, and each of the externalized relations indicates each externalized sequence from one of the externalized elements to another one of the externalized elements;
wherein each of the plurality of structures derived from a corresponding one of the plurality of externalizations of users' mental models comprises a plurality of elements and a plurality of relations thereof, each of the plurality of elements is obtained via a text, an image, a sound, a video or any symbols representing a user's concept, conception, idea or other mental contents, and each of the plurality of relations is obtained as a hierarchy, a sequential order, a logical dependency or other specified states of affairs among the plurality of elements and indicates each sequence from one of the plurality of elements to another one of the plurality of elements.

5. The computer system of claim 4, wherein the method further comprising:
receiving corresponding relevant data associated with the plurality of structures and establishing a reference data store for the corresponding relevant data.

6. The computer system of claim 4, wherein the predetermined principle of normalization comprises a segmentation information representing a particular number indicating a length of memory span.

7. The computer system of claim 4, further comprising a user interface for users to create, edit, collect, or share users' mental models.

8. A method for searching a plurality of structures, which are derived from a plurality of externalizations of users' mental models, the method comprising:
receiving at least one search query identifying one of the plurality of structures;
analyzing the at least one structure according to a predetermined principle of normalization, to obtain a plurality of search analysis results in a form of a plurality of tuples comprising a plurality of elements and/or a plurality of relations thereof related to the plurality of structures;
processing an identification search process to identify, in an index store, a plurality of structures comprising at least one of the plurality of tuples;
performing a calculation operation for a plurality of identified structures according to predetermined principles of relevancy, so as to obtain a plurality of relevancy analysis results;
ranking the plurality of identified structures according to the plurality of relevancy analysis results, to obtain a search report; and
outputting the search report to a user's terminal;
wherein the predetermined principles of relevancy comprise at least one or more principles of similarity calculation for the plurality of structures, and the plurality of externalizations of users' mental models are obtained via a mind map, a concept map, a knowledge map, a diagram, a flow, a chart, or a category;
wherein each of the plurality of externalizations of users' mental models is an established mental schema or cognition for interpreting users' understandings of certain search targets in a form of externalized elements and externalized relations thereof, and each of the externalized relations indicates each externalized sequence from one of the externalized elements to another one of the externalized elements;
wherein each of the plurality of structures derived from a corresponding one of the plurality of externalizations of users' mental models comprises a plurality of elements and a plurality of relations thereof, each of the plurality of elements is obtained via a text, an image, a sound, a video or any symbols representing a user's concept, conception, idea or other mental contents, and each of the plurality of relations is obtained as a hierarchy, a sequential order, a logical dependency or other specified states of affairs among the plurality of elements and indicates each sequence from one of the plurality of elements to another one of the plurality of elements.

9. The method of claim 8, wherein the identification search process further comprises accessing a reference data store of corresponding relevant data associated with the plurality of identified structures and preparing the accessed reference data accordingly for further utilization.

10. The method of claim 8, wherein the search report comprises a list of the plurality of identified structures in a rank of relevancy analysis results and/or the corresponding relevant data associated with the plurality of identified structures accordingly.

11. The method of claim 8, wherein the predetermined principle of normalization comprises a segmentation information representing a particular number indicating a length of memory span.

12. The method of claim 8, wherein the plurality of relations of the plurality of structures comprise a plurality of path information to form a structural information, rather than split tokens, phrases or words, for the users to perform indexing and searching of the search query.

13. A computer system for searching a plurality of structures, which are derived from a plurality of externalizations of users' mental models, the computer system comprising:
a central processing unit; a user interface coupled to the central processing unit; and
a storage device coupled to the central processing unit for storing a programming code, and the programming code is utilized to instruct the central processing unit for processing a method comprising:
receiving at least one search query identifying one of the plurality of structures via the user interface;
analyzing the at least one structure according to a predetermined principle of normalization, to obtain a plurality of search analysis results in a form of a plurality of tuples comprising a plurality of elements and/or a plurality of relations thereof related to the plurality of structures;
processing an identification search process to identify, in an index store, a plurality of structures comprising at least one of the plurality of tuples;
performing a calculation operation for a plurality of identified structures according to predetermined principles of relevancy, so as to obtain a plurality of relevancy analysis results;
ranking the plurality of identified structures according to the plurality of relevancy analysis results, to obtain a search report; and
outputting the search report to a user's terminal via the user interface;
wherein the predetermined principles of relevancy comprise at least one or more principles of similarity calculation for the plurality of structures, and the plurality of externalizations of users' mental models are obtained via a mind map, a concept map, a knowledge map, a diagram, a flow, a chart, or a category;
wherein each of the plurality of externalizations of users' mental models is an established mental schema or cognition for interpreting users' understandings of certain search targets in a form of externalized elements and externalized relations thereof, and each of the externalized relations indicates each externalized sequence from one of the externalized elements to another one of the externalized elements;
wherein each of the plurality of structures derived from a corresponding one of the plurality of externalizations of users' mental models comprises a plurality of elements and a plurality of relations thereof, each of the plurality of elements is obtained via a text, an image, a sound, a video or any symbols representing a user's concept, conception, idea or other mental contents, and each of the plurality of relations is obtained as a hierarchy, a sequential order, a logical dependency or other specified states of affairs among the plurality of elements and indicates each sequence from one of the plurality of elements to another one of the plurality of elements.

14. The computer system of claim 13, wherein the identification search process further comprises accessing a reference data store of corresponding relevant data associated with the plurality of identified structures and preparing the accessed reference data accordingly for further utilization.

15. The computer system of claim 13, wherein the search report comprises a list of the plurality of identified structures in a rank of relevancy analysis results and/or the corresponding relevant data associated with the plurality of identified structures accordingly.

16. The computer system of claim 13, further comprising a user interface for users to create, edit, collect, or share users' mental model.

17. The computer system of claim 13, wherein the predetermined principle of normalization comprises a segmentation information representing a particular number indicating a length of memory span.

18. The computer system of claim 13, wherein the plurality of relations of the plurality of structures comprise a plurality of path information to form a structural information, rather than split tokens, phrases or words, for the users to perform indexing and searching of the search query.
